(19) United States
(12) Patent Application Publication
(10) Pub. No.: US 2014/0335500 A1
(43) Pub. Date: Nov. 13, 2014

(54) METHOD AND SYSTEM FOR RECORDING EMOTIONAL STATE OF A USER

(71) Applicants: Lakshya Jain, Los Altos, CA (US); Jawahar Jain, Los Altos, CA (US)

(72) Inventors: Lakshya Jain, Los Altos, CA (US); Jawahar Jain, Los Altos, CA (US)

(21) Appl. No.: 14/318,584

(22) Filed: Jun. 28, 2014

(51) Int. Cl. G06Q 30/02

(52) U.S. Cl. CPC G06Q 30/0269
USPC 434/362

(57) ABSTRACT

The present disclosure provides a method and system for recording emotional state of one or more users is provided. The method and system includes providing one or more pre-defined set of questionnaires for a web-based displayed content, recording responses of the one or more users pertaining to the web-based displayed content for the one or more pre-defined set of questionnaires, analyzing responses of each of the one or more users for each of the one or more pre-defined set of questionnaires for the web-based displayed content and generating an emotion profile report for the web-based displayed content for each of the one or more users based on analyzed responses.

### TECHNICAL FIELD

The present invention relates to recording emotional state of users, and more specifically, relates to real-time recording and analysis of emotional state of the users.

### BACKGROUND

In this Internet era, users are continuously being exposed to a variety of content by different content providers. The content providers can be social networking platforms, news websites, blogging websites, press release websites, and the like. Most of the times, these content providers publish the content for directly or indirectly advertising product and/or service offerings. Generally, the stakeholders associated with these content providers want to use the feedback of the users for various purposes including statistical analysis of visitors on their websites, popularity of the electronic information/content posted by them on their websites, analyzing of emotional state/mood of the users after viewing or reading the electronic information/content posted by them on their websites and the like. The stakeholders use this feedback for refining their marketing strategy, improvising their product and/or service offerings, and the like.

Traditionally, some websites allow the users to provide their comments, feedback, inputs and the like on the electronic information/content posted on them. These websites utilize traditional ways of taking comments, feedback, inputs and the like from the users. For example, some websites provide one or more of feedback form, option of writing comments and like button/tab on their webpage. However, the users may or may not provide their comments, feedback, inputs and the like. Moreover, traditional methods and systems of collecting feedback do not stimulate the users to provide comments, feedback, inputs and the like on the electronic information/content posted on the websites. Further, the traditional methods and system do not efficiently allow capturing real behaviour of the user before, after and/or during the course of reading of the content. The non-efficient manner of capturing real behaviour of the users leads to an improper improvisation in refining the marketing strategy, product and/or service offerings, and the like.

In view of aforementioned problems discussed above, there is a need for a method and a system which overcomes the above stated problems. In addition, the method and system should efficiently record the emotional profile of users and provide a real time analysis to the stakeholders.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

The present invention provides a method for recording emotional state of one or more users is provided. The method includes providing one or more pre-defined set of questionnaires for a web-based displayed content, recording responses of the one or more users pertaining to the web-based displayed content for the one or more pre-defined set of questionnaires, analyzing responses of each of the one or more users for each of the one or more pre-defined set of questionnaires for the web-based displayed content and generating an emotion profile report for the web-based displayed content for each of the one or more users based on analyzed responses.

In an embodiment, the method includes generating a feedback report having at least one of the corresponding emotional profile reports of the one or more users and a consolidated report of responses generated by analysis of responses of each of the one or more users for each of one or more pre-defined set of questionnaires for the web-based displayed content.

In an embodiment, analyzing responses of each of the one or more users for each of the one or more pre-defined set of questionnaires for the web-based displayed content includes comparing responses for each of the one or more pre-defined set of questionnaires of each of the one or more users with one another.

In another embodiment, analyzing responses of each of the one or more users for each of the one or more pre-defined set of questionnaires for the web-based displayed content includes comparing responses of each of the one or more users from a pre-defined set of responses for each of the one or more pre-defined set of questionnaires.

In an embodiment, the one or more pre-defined set of questionnaires for the web-based displayed content is provided at pre-defined time intervals on the web-based platform.

In another embodiment, the one or more pre-defined set of questionnaires for the web-based displayed content is provided on a web browser of each of the one or more users through a temporary prompting window. The web-browser enables the temporary prompting window to provide the one or more pre-defined set of questionnaires for the web-based displayed content.

In another embodiment, the one or more pre-defined set of questionnaires for the web-based displayed content is provided utilizing an extension in the web browser corresponding to each of the one or more users.

In another aspect of the present disclosure, a system for recording emotional state of the one or more users is provided. The system includes an input/output module configured to provide the one or more pre-defined set of questionnaires for the web-based displayed content, a database configured to record responses of the one or more users for the one or more pre-defined set of questionnaires pertaining to the web-based displayed content, an analysis module configured to analyze responses of each of the one or more users for each of the one or more pre-defined set of questionnaires for the web-based displayed content and a report generator module configured to generate the emotion profile report for the web-based displayed content for each of the one or more users based on analyzed responses. The web-based displayed content is read by the one or more users on the web-based platform.

In an embodiment, the report generator module is configured to generate a feedback report having at least one of the corresponding emotional profile reports of the one or more users and the consolidated report of responses generated by analysis of responses of each of the one or more users for each of the one or more pre-defined set of questionnaires for the web-based displayed content.

In an embodiment, the analysis module configured to analyze responses of each of the one or more users for each of the one or more pre-defined set of questionnaires for the web-based displayed content is configured to compare responses for each of the one or more pre-defined set of questionnaires of each of the one or more users with one another.

In an embodiment, the analysis module configured to analyze responses of each of the one or more users for each of the one or more pre-defined set of questionnaires for the web-based displayed content is configured to compare responses of each of the one or more users from the pre-defined set of responses for each of the one or more pre-defined set of questionnaires.

In an embodiment, the input/output module provides the one or more pre-defined set of questionnaires for the web-based displayed content at pre-defined time intervals on the web-based platform.

In an embodiment, the input/output module provides the one or more pre-defined set of questionnaires for the web-based displayed content on the web browser of each of the one or more users through the temporary prompting window.

In an embodiment, the input/output module is configured to provide the one or more pre-defined set of questionnaires for the web-based displayed content on the web browser of each of the one or more users through the temporary prompting window. The web-browser enables the temporary prompting window to provide the one or more pre-defined set of questionnaires for the web-based displayed content.

In yet another aspect of the present disclosure, a computer system for generating the emotional profile report of each of the one or more users is provided. The computer system includes one or more processors and a non-transitory memory including instructions that, when executed by the one or more processors, causes the one or more processors to perform a set of steps. The set of steps includes providing, by the input/output module, the one or more pre-defined set of questionnaires for the web-based displayed content; recording, by the database, responses of the one or more users pertaining to the web-based displayed content for the one or more pre-defined set of questionnaires; analyzing, by the analysis module, responses of each of the one or more users for each of the one or more pre-defined set of questionnaires for the web-based displayed content and generating, by the report generator module, the emotion profile report for the web-based displayed content for each of the one or more users based on analyzed responses.

In an embodiment, the non-transitory memory includes instructions that, when executed by the one or more processors, cause the one or more processors to perform a further step of generating the feedback report having at least one of the corresponding emotional profile reports of the one or more users and the consolidated report of responses generated by analysis of responses of each of the one or more users for each of the one or more pre-defined set of questionnaires for the web-based displayed content.

In an embodiment, the computer system for analyzing responses of each of the one or more users for each of the one or more pre-defined set of questionnaires for the web-based displayed content includes comparing responses for each of the one or more pre-defined set of questionnaires of each of the one or more users with one another.

In an embodiment, the computer system for analyzing responses of each of the one or more users for each of the one or more pre-defined set of questionnaires for the web-based displayed content includes comparing responses of each of the one or more users from the pre-defined set of responses for each of the one or more pre-defined set of questionnaires.

In an embodiment, the one or more pre-defined set of questionnaires for the web-based displayed content is provided at pre-defined time intervals on the web-based platform.

In an embodiment, the one or more pre-defined set of questionnaires for the web-based displayed content is provided on the web browser of each of the one or more users through the temporary prompting window. The web-browser enables the temporary prompting window to provide the one or more pre-defined set of questionnaires for the web-based displayed content.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1A illustrates a system for enabling recording and analysis of emotional state of various users, in accordance with various embodiments of the present disclosure;

FIG. 1B illustrates an example embodiment of the system for enabling recording and analysis of emotional state, in accordance with various embodiments of the present disclosure;

FIG. 2 illustrates a block diagram of a server, in accordance with various embodiments of the present disclosure;

FIG. 3 illustrates a flowchart for recording and analyzing emotional state of a user, in accordance with an embodiment of the present disclosure; and

FIG. 4 illustrates a block diagram of a dedicated computer that acts as the server, in accordance with various embodiments of the present disclosure.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

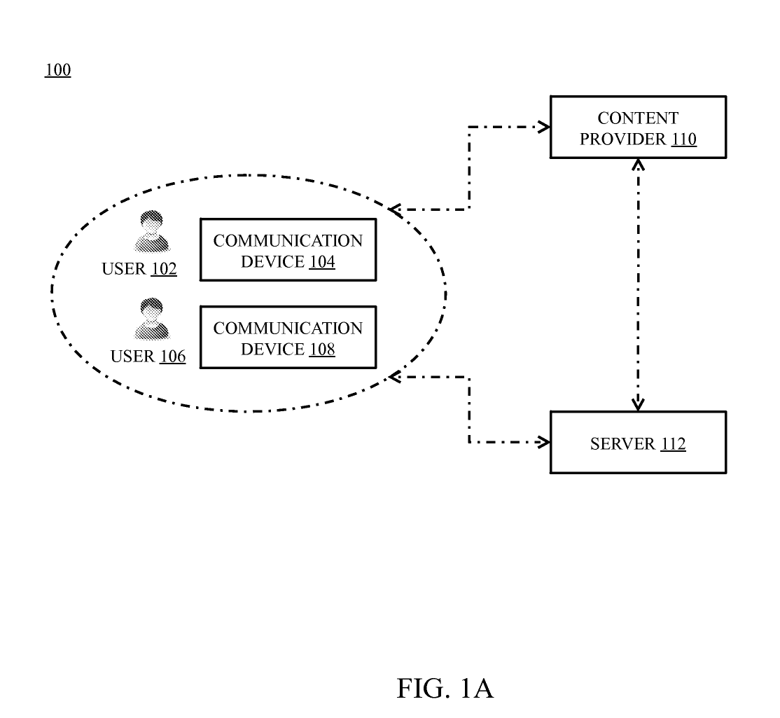

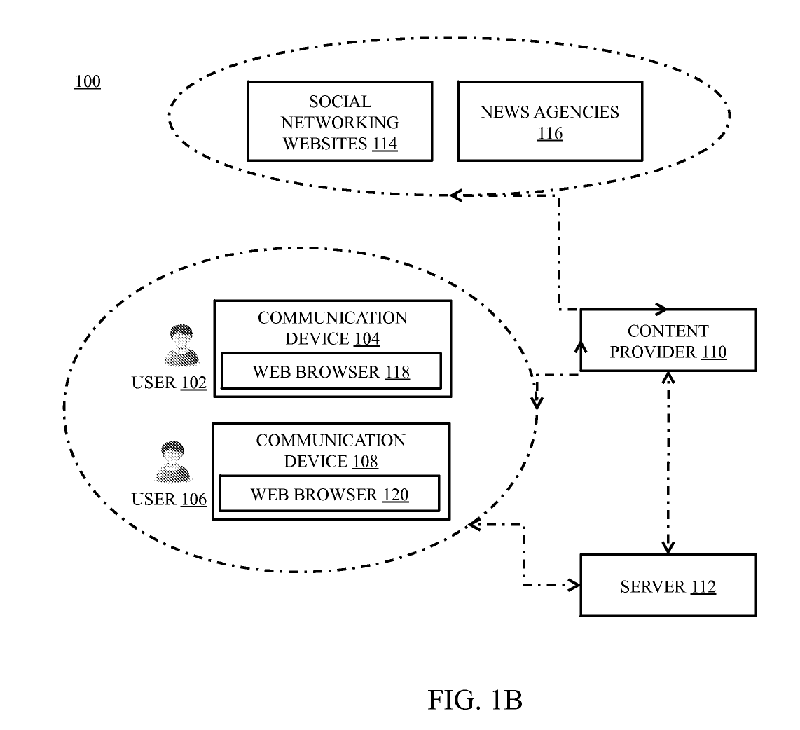

FIG. 1A illustrates a system 100 for enabling recording and analysis of emotional state, in accordance with various embodiments of the present disclosure. The system 100 includes a communication device 104, a communication device 108, a content provider 110 and a server 112. The communication device 104 is associated with a user 102 and the communication device 108 is associated with a user 106. Moreover, each of the communication device 104, the communication device 108, the content provider 110 and the server 112 are linked to one another through a communication link. Examples of the communication link include, but may not be limited to a local area network (LAN), wide area network (WAN), radio link, microwave link and Wi-Fi.

In an embodiment of the present disclosure, the content provider 110 provides a web-based displayed content. The web-based displayed content provided by the content provider 110 can be related to various issues/topics including current affairs, political, environmental, social, and the like. The user 2102 and the user 106 access the web-based displayed content from a web-based platform. The server 112 interacts with the communication device 104, the communication device 108 and the content provider 110 and captures data of the communication device 104, the communication device 108 and the content provider 110. In addition, the server 112 may analyze, manipulate and process the data of the communication device 104, the communication device 108 and the content provider 110.

It may be noted that in FIG. 1, the user 2102 and the user 106, having the communication device 104 and the communication device 108, are shown to interact with the content provider 110 and the server 112; however, those skilled in the art would appreciate that multiple users, having a communication device each, can interact with the content provider 110 and the server 112. Moreover, the content provider 110 may publish the content on a plurality of websites including an advertising website, a news website, a social media website and the like that provide the web-based displayed content. For example, a content provider X posts an article A on a social media website and N number of users reads the article A. Moreover, out of N, M users are affected after reading the article A. However, data related to “how the M users are affected?” might be used by many individuals, companies, the content provider X and the like for various purposes. The content provider X may use the data to evaluate the impact of the article A on the users or to track the popularity of the article. Moreover, the companies and individuals may use the data to analyze emotional impact/mood of the users. For example, a company Y may prepare a report regarding the number of users whose mood got better after reading the article A.

FIG. 1B illustrates an example embodiment of the system 100 for enabling recording and analysis of emotional state, in accordance with various embodiments of the present disclosure. It may be noted that to explain the system 100 for enabling recording and analysis of emotional state, references will be made to the various elements of the system 100 shown in FIG. 1A.

As explained above, in the description of FIG. 1A, the system 100 includes the communication device 104, the communication device 108, the content provider 110 and the server 112. In an embodiment of the present disclosure, the content provider 110 fetches the web-based displayed content from social networking websites 114, news agencies 116 and the like. In addition, the communication device 104 and the communication device 108 include a web browser 118 and a web browser 120 respectively. The web browser 118 and the web browser 120 enable the user 102 and the user 106 to read the web-based displayed content from the web-based platform. Further, the web browser 118 and the web browser 120 enable the user 102 and the user 106 to access various other contents provided by the server 112.

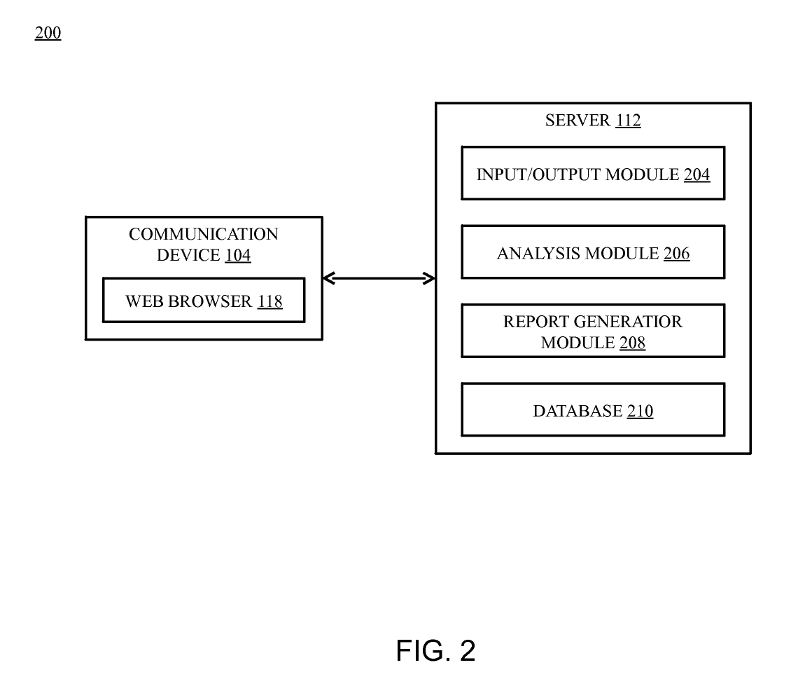

FIG. 2 illustrates a block diagram 200 of the server 112, in accordance with various embodiments of the present disclosure. It may be noted that to explain the block diagram 200 of the server 112, references will be made to the various elements of the system 100.

The server 112 includes an input/output module 204, an analysis module 206, a report generator module 208 and a database 210. The input/output module 204 provides one or more pre-defined set of questionnaires corresponding to the web-based displayed content to the communication device 104 of the user 102. Examples of the one or more pre-defined set of questionnaires include “how are you feeling after reading the article?”, “what is your mood?” and the like. The user 102 reads the web-based displayed content from the web-based platform on the web browser 118 using the communication device 104. In addition, corresponding to the web-based displayed content, the user 102 gets the one or more pre-defined set of questionnaires from the input/output module 204. The user 102 responds to the one or more pre-defined set of questionnaires using the communication device 104. The server 112 records the responses of the user 102 corresponding to the one or more pre-defined set of questionnaires in the database 210. Further, the analysis module 206 analyzes responses of the user 102 corresponding to the one or more pre-defined set of questionnaires. Furthermore, the report generator module 208 generates an emotion profile report of the user 102 on the basis of analysis of the responses of the user 102. For example, the emotional profile report of the user 102 may indicate that mood of the user 102 got better after reading the article A.

It may be noted that in FIG. 2, the server 112 is shown to interact with the communication device 104; however, those skilled in the art would appreciate that the server 112 interacts with more than one communication device. Moreover, the server 112 provides the one or more pre-defined set of questionnaires to more than one communication device. Further, the server 112 records and compares responses from more than one communication device.

In an embodiment of the present disclosure, the input/output module 204 of the server 112 provides one of the one or more pre-defined set of questionnaires prior to reading of the web-based displayed content by the user 102. For example, the server 112 may ask a question, “how is your mood?” prior to the reading of the article A by the user 102. Moreover, the input/output module 204 of the server 112 provides second of the one or more pre-defined set of questionnaires following the reading of the web-based displayed content by the user 102. For example, the server 112 may again ask a same or different question, “how is your mood?” or “has your mood got better?” following the reading of the article A by the user 102. The analysis module 206 of the server 112 analyzes the responses of the user 102 for each of the one or more pre-defined set of questionnaires and the report generator module 208 generates an emotion profile report of the user 102 by comparing the responses of the user 102.

In another embodiment of the present disclosure, the input/output module 204 of the server 112 provides one of the one or more pre-defined set of questionnaires following the reading of the web-based displayed content by the user 102. For example, the server 112 may provide a questionnaire asking a question to the user 102, “how is your mood now?” following the reading of the article A by the user 102. In addition, the server 112 provides one or more pre-defined set of responses corresponding to the one or more pre-defined set of questionnaires. For example, the server 112 may provide a set of three responses to the user 102 including “excellent”, “relaxed” and “tensed”. Thus, the user 112 can select one of the set of three responses. The analysis module 206 compares the response selected by the user 102 from the pre-defined set of responses provided to the user 2102. For example, if the user 102 selects excellent after reading the article A, then it can be assumed that the article A is excellent and the mood of the user 102 improved after reading the article A.

In yet another embodiment of the present disclosure, the report generator module 208 generates a feedback report having at least one of the corresponding emotional profile reports of the one or more users (the user 102 and the user 106) and a consolidated report of responses generated by analysis of responses of each of said one or more users (the user 102 and the user 106) for each of one or more pre-defined set of questionnaires for the web-based displayed content.

In yet another embodiment of the present disclosure, the analysis module 206 compares the responses for each of the one or more pre-defined set of questionnaires of each of the one or more users (the user 102 and the user 106) with one another.

In yet another embodiment of the present disclosure, the analysis module 206 compares the responses of each of the one or more users (the user 102 and the user 106) from a pre-defined set of responses for each of the one or more pre-defined set of questionnaires.

In yet another embodiment of the present disclosure, the input/output module 204 provides the one or more pre-defined set of questionnaires for the web-based displayed content at pre-defined time intervals on the web-based platform.

In yet another embodiment of the present disclosure, the input/output module 204 provides the one or more pre-defined set of questionnaires for the web-based displayed content on the web browser 118 of each of the one or more users (the user 102 and the user 106) through a temporary prompting window. For example, the input/output module 204 may ask a set of questions from the user 102 through a pop-up notification in the web browser 118.

In yet another embodiment of the present disclosure, the input/output module 204 provides the one or more pre-defined set of questionnaires for the web-based displayed content on the web browser 118 of each of the one or more users (the user 102 and the user 106) through the temporary prompting window. Moreover, the web browser 118 enables the temporary prompting window to provide the one or more pre-defined set of questionnaires for the web-based displayed content. In yet another embodiment of the present disclosure, the analysis module 206 of the server 112 tracks frequency with which each of the one or more users (the user 102 and the user 106) interact with applications and the one or more pre-defined set of questionnaires provided by the server 112. Thus, the server 112 can analyze interests and openness of the one or more users (the user 102 and the user 106) for applications, events, products and the like provided by the stakeholders.

In yet another embodiment of the present disclosure, the analysis module 206 of the server 112 tracks outliers in user's behaviour and modifies the emotional profile report accordingly in real time. For example, if a user U1 provides a negative response for the one or more pre-defined set of questionnaires provided corresponding to a certain web-based displayed content W having maximum positive reviews (indicating better emotional state of users), and then the analysis module 206 may infer presence of outlier. Moreover, the analysis module 206 may infer level of change in behaviour of U1. Further, the report generator module 208 may accordingly modify the emotional profile report of the user U1 by coordinating with the analysis module 206 of the server 112.

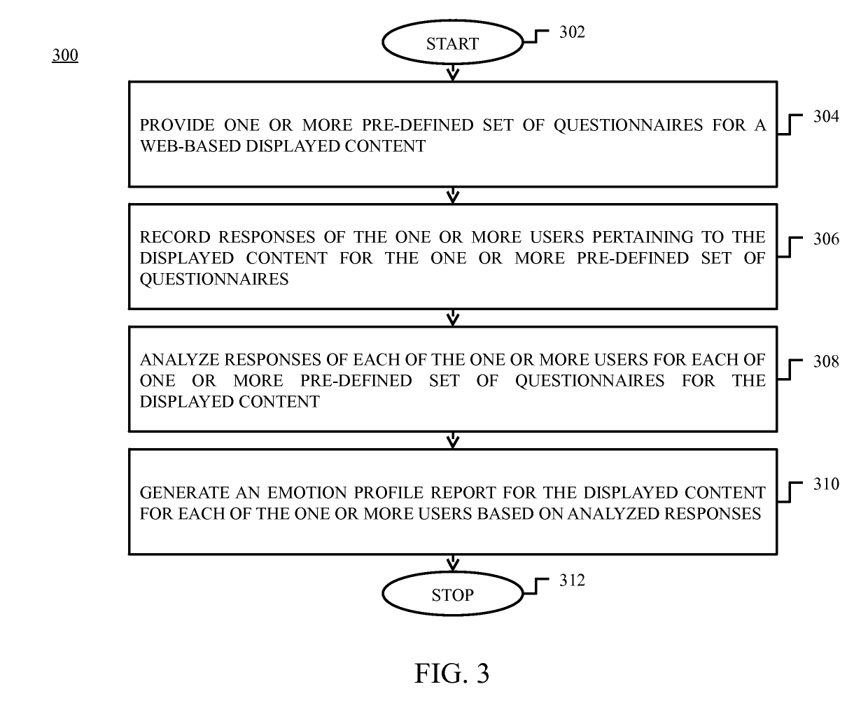

FIG. 3 is a flowchart 300 for recording and analyzing an emotional state of the user 102 and the user 106, in accordance with various embodiments of the present disclosure. It may be noted that to explain the flowchart 300 for recording and analyzing an emotional state of the user 102 and the user 106 by the server 112, references will be made to the various elements of the system 100 and the block diagram 200.

The flowchart initiates at step 302. At step 304, as mentioned above, the server 112 provides the one or more pre-defined set of questionnaires for the web-based displayed content. The one or more users read the web-based displayed content on the web-based platform. Moreover, at pre-defined time intervals, the server 112 prompts the one or more pre-defined set of questionnaires on the web browser of the one or more users.

In an embodiment of the present disclosure, the input/output module 204 provides the one or more pre-defined set of questionnaires for the web-based displayed content on the web browser 118 of each of the one or more users (the user 102 and the user 106) through a temporary prompting window. Following step 304, at step 306, as mentioned above, the server 112 records the responses submitted by the users. The responses pertain to the web-based displayed content for the one or more pre-defined set of questionnaires. Following step 306, at a step 308, the server 112 analyzes the responses of each of the one or more users for each of the one or more pre-defined set of questionnaires for the web-based displayed content.

In an embodiment of the present disclosure, the analysis module 206 compares the responses for each of the one or more pre-defined set of questionnaires of each of the one or more users (the user 102 and the user 106) with one another. In another embodiment of the present disclosure, the analysis module 206 compares the responses of each of the one or more users (the user 102 and the user 106) from a pre-defined set of responses for each of the one or more pre-defined set of questionnaires. Following the step 308, at step 310, as mentioned above, the server 112 generates the emotion profile report for the web-based displayed content for each of the one or more users based on analyzed responses. In an embodiment of the present disclosure, the report generator module 208 generates a feedback report having at least one of the corresponding emotional profile reports of the one or more users (the user 102 and the user 106) and a consolidated report of responses generated by analysis of responses of each of said one or more users (the user 102 and the user 106) for each of one or more pre-defined set of questionnaires for the web-based displayed content. The flowchart 300 terminates at step 312.

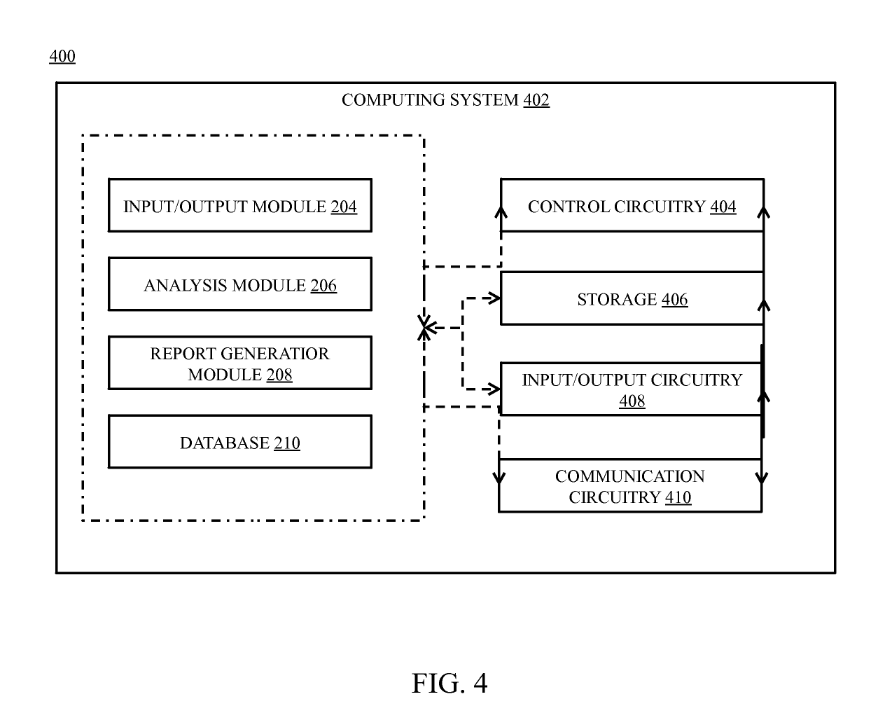

FIG. 4 illustrates a block diagram 400 of a dedicated computer 402 that acts as the server 112, in accordance with various embodiments of the present disclosure. It may be noted that to explain the block diagram 400 of the dedicated computer 402 that acts as the server 112, references will be made to the various elements of the system 100 and the block diagram 200.

The dedicated computer 402 includes but may not be limited to a control circuitry 404, storage 406, an input/output circuitry 408, and a communication circuitry 410.

From the perspective of this invention, the control circuitry 404 includes any processing circuitry or processor operative to control the operations and performance of the dedicated computer 402. For example, the control circuitry 404 may be used to run operating system applications, firmware applications, media playback applications, media editing applications, or any other application. In an embodiment, the control circuitry 404 drives a display and process inputs received from a user interface.

From the perspective of this invention, the storage 406 includes one or more storage mediums including a hard-drive, solid state drive, flash memory, permanent memory such as ROM, any other suitable type of storage component, or any combination thereof. The Storage 406 may store, for example, media data (e.g., music and video files), application data (e.g., for implementing functions on the dedicated computer 402).

From the perspective of this invention, the I/O circuitry 408 may be operative to convert (and encode/decode, if necessary) analog signals and other signals into digital data. In an embodiment, the I/O circuitry 408 may also convert digital data into any other type of signal, and vice-versa. For example, the I/O circuitry 408 may receive and convert physical contact inputs (e.g., from a multi-touch screen), physical movements (e.g., from a mouse or sensor), analog audio signals (e.g., from a microphone), or any other input. The digital data may be provided to and received from the control circuitry 404, the storage 406, or any other component of the dedicated computer 402.

It may be noted that the I/O circuitry 408 is illustrated in FIG. 3 as a single component of the dedicated computer 402; however those skilled in the art would appreciate that several instances of the I/O circuitry 408 may be included in the dedicated computer 402.

The dedicated computer 402 may include any suitable interface or component for allowing a user to provide inputs to the I/O circuitry 408. The dedicated computer 402 may include any suitable input mechanism. Examples of the input mechanism include but may not be limited to a button, keypad, dial, a click wheel, and a touch screen. In an embodiment of the present disclosure, the dedicated computer 402 may include a capacitive sensing mechanism, or a multi-touch capacitive sensing mechanism.

In an embodiment, the dedicated computer 402 may include specialized output circuitry associated with output devices such as, for example, one or more audio outputs. The audio output may include one or more speakers built into the dedicated computer 402, or an audio component that may be remotely coupled to the dedicated computer 402.

The one or more speakers can be mono speakers, stereo speakers, or a combination of both. The audio component can be a headset, headphones or ear buds that may be coupled to communications device with a wire or wirelessly.

In an embodiment, the I/O circuitry 408 may include display circuitry for providing a display visible to the user. For example, the display circuitry may include a screen (e.g., an LCD screen) that is incorporated in the dedicated computer 402.

The display circuitry may include a movable display or a projecting system for providing a display of content on a surface remote from the dedicated computer 402 (e.g., a video projector). In an embodiment, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry 404. Alternatively, the display circuitry may be operative to provide instructions to a remote display.

From the prospective of this invention, the communications circuitry 410 may include any suitable communications circuitry operative to connect to a communications network and to transmit communications (e.g., voice or data) from the dedicated computer 402 to other devices within the communications network. The communications circuitry 410 may be operative to interface with the communications network using any suitable communications protocol. Examples of the communications protocol include but may not be limited to Wi-Fi, Bluetooth, RTM, radio frequency systems, infrared, LTE, GSM, GSM plus EDGE, CDMA, and quadband.

In an embodiment of the present disclosure, the same instance of the communications circuitry 410 may be operative to provide for communications over several communications networks. In an embodiment of the present disclosure, the dedicated computer 402 may be coupled a host device for data transfers, synching the communications device, software or firmware updates, providing performance information to a remote source (e.g., providing riding characteristics to a remote server) or performing any other suitable operation that may require the dedicated computer 402 to be coupled to a host device. Several computing devices may be coupled to a single host device using the host device as a server. Alternatively or additionally, the dedicated computer 402 may be coupled to several host devices (e.g., for each of the plurality of the host devices to serve as a backup for data stored in the dedicated computer 402).

In an embodiment of the present disclosure, a method and system for collecting feedback of the one or more users stimulates the one or more users to provide comments, feedback, inputs and the like on the web-based displayed content posted on the web-based platforms. In addition, the method and system allows efficient capturing of real behaviour of the one or more users before, after and/or during the course of reading of the web-based displayed content. Efficient capturing of real behaviour of the one or more users leads to a proper improvisation in refining the marketing strategy, product and/or service offerings, and the like. Further, the method and system provides consolidated reviews/opinion of the one or more users on the web-based displayed content provided by the content provider to the stakeholders. Furthermore, the method and system dynamically generates the emotion profile report of the one or more users and provides a real time analysis to the stakeholders.

The foregoing descriptions, of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method comprising:
providing one or more pre-defined set of questionnaires for a web-based displayed content, wherein said web-based displayed content being read by said one or more users on a web-based platform;
recording responses of said one or more users pertaining to said web-based displayed content for said one or more pre-defined set of questionnaires;
analyzing responses of each of said one or more users for each of said one or more pre-defined set of questionnaires for said web-based displayed content; and
generating an emotion profile report for said web-based displayed content for each of said one or more users based on analyzed responses.

2. The method as recited in claim 1, further comprising generating a feedback report having at least one of said corresponding emotional profile report of said one or more users and a consolidated report of responses generated by analysis of responses of each of said one or more users for each of said one or more pre-defined set of questionnaires for said web-based displayed content.

3. The method as recited in claim 1, wherein analyzing responses of each of said one or more users for each of said one or more pre-defined set of questionnaires for said web-based displayed content further comprises comparing responses for each of said one or more pre-defined set of questionnaires of each of said one or more users with one another.

4. The method as recited in claim 1, wherein analyzing responses of each of said one or more users for each of said one or more pre-defined set of questionnaires for said web-based displayed content further comprises comparing responses of each of said one or more users from a pre-defined set of responses for each of said one or more pre-defined set of questionnaires.

5. The method as recited in claim 1, wherein said one or more pre-defined set of questionnaires for said web-based displayed content being provided at pre-defined time intervals on said web-based platform.

6. The method as recited in claim 5, wherein said one or more pre-defined set of questionnaires for said web-based displayed content being provided on a web browser of each of said one or more users through a temporary prompting window, wherein said web-browser enables said temporary prompting window to provide said one or more pre-defined set of questionnaires for said web-based displayed content.

7. The method as recited in claim 5, wherein said one or more pre-defined set of questionnaires for said web-based displayed content being provided utilizing an extension in said web browser corresponding to each of said one or more users.

8. A system comprising:
an input/output module configured to provide one or more pre-defined set of questionnaires for a web-based displayed content, wherein said web-based displayed content being read by one or more users on a web-based platform;
a database configured to record responses of said one or more users for said one or more pre-defined set of questionnaires pertaining to said web-based displayed content;
an analysis module configured to analyze responses of each of said one or more users for each of said one or more pre-defined set of questionnaires for said web-based displayed content; and
a report generator module configured to generate an emotion profile report for said web-based displayed content for each of said one or more users based on analyzed responses.

9. The system as recited in claim 8, wherein said report generator module further configured to generate a feedback report having at least one of said corresponding emotional profile reports of said one or more users and a consolidated report of responses generated by analysis of responses of each of said one or more users for each of said one or more pre-defined set of questionnaires for said web-based displayed content.

10. The system as recited in claim 8, wherein said analysis module configured to analyze responses of each of said one or more users for each of one or more pre-defined set of questionnaires for said web-based displayed content is further configured to compare responses for each of said one or more pre-defined set of questionnaires of each of said one or more users with one another.

11. The system as recited in claim 8, wherein said analysis module configured to analyze responses of each of said one or more users for each of one or more pre-defined set of questionnaires for said web-based displayed content is further configured to compare responses of each of said one or more users from a pre-defined set of responses for each of said one or more pre-defined set of questionnaires.

12. The system as recited in claim 8, wherein said input/output module provides said one or more pre-defined set of questionnaires for said web-based displayed content at pre-defined time intervals on said web-based platform.

13. The system as recited in claim 8, wherein said input/output module provides said one or more pre-defined set of questionnaires for said web-based displayed content on a web browser of each of said one or more users through a temporary prompting window.

14. The system as recited in claim 13, wherein said input/output module is configured to provide said one or more pre-defined set of questionnaires for said web-based displayed content on said web browser of each of said one or more users through said temporary prompting window, wherein said web-browser enables said temporary prompting window to provide one or more pre-defined set of questionnaires for said web-based displayed content.

15. A computer system for generating an emotion profile report of each of a one or more users, said system comprising:
one or more processors; and
a non-transitory memory containing instructions that, when executed by said one or more processors, causes said one or more processors to perform a set of steps comprising:
providing, by an input/output module, one or more pre-defined set of questionnaires for a web-based displayed content, wherein said web-based displayed content being read by said one or more users on a web-based platform;
recording, by a database, responses of said one or more users pertaining to said web-based displayed content for said one or more pre-defined set of questionnaires;
analyzing, by an analysis module, responses of each of said one or more users for each of said one or more pre-defined set of questionnaires for said web-based displayed content; and
generating, by a report generator module, an emotion profile report for said web-based displayed content for each of said one or more users based on analyzed responses.

16. The computer system as recited in claim 15, wherein said non-transitory memory containing instructions that, when executed by said one or more processors, cause said one or more processors to perform a further step of generating a feedback report having at least one of said corresponding emotional profile reports of said one or more users and a consolidated report of responses generated by analysis of responses of each of said one or more users for each of said one or more pre-defined set of questionnaires for said web-based displayed content.

17. The computer system as recited in claim 15, wherein said analyzing responses of each of said one or more users for each of said one or more pre-defined set of questionnaires for said web-based displayed content further comprises comparing responses for each of said one or more pre-defined set of questionnaires of each of said one or more users with one another.

18. The computer system as recited in claim 15, wherein said analyzing responses of each of said one or more users for each of said one or more pre-defined set of questionnaires for said web-based displayed content further comprises comparing responses of each of said one or more users from a pre-defined set of responses for each of said one or more pre-defined set of questionnaires.

19. The computer system as recited in claim 15, wherein said one or more pre-defined set of questionnaires for said web-based displayed content being provided at pre-defined time intervals on said web-based platform.

20. The computer system as recited in claim 15, wherein said one or more pre-defined set of questionnaires for said web-based displayed content being provided on a web browser of each of said one or more users through a temporary prompting window, wherein said web-browser enables said temporary prompting window to provide said one or more pre-defined set of questionnaires for said web-based displayed content.
